(19) United States
(12) Patent Application Publication
(10) Pub. No.: US 2005/0188103 A1
(43) Pub. Date: Aug. 25, 2005

(54) Method or device for delivering a packet in a scatternet

(75) Inventor: Hongyuan Chen, Tokyo (JP)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/749,945

(22) Filed: Dec. 30, 2003

(51) Int. Cl. G06F 15/173

(52) U.S. Cl. 709/238; 709/208

(57) ABSTRACT

A method of delivering a packet from a first device in a first piconet of a scatternet to a destination device in a second piconet of the scatternet comprising: creating a direct radio communications link between the first device and the destination device; and transmitting the packet via the direct radio communications link. Alternatively, a method of delivering a packet from a first device in a first piconet of a scatternet to a destination device in a second piconet of that scatternet comprising: creating a third piconet between the first piconet and the second piconet; and transmitting the packet via the third piconet. Alternatively, a method of delivering a packet from a first device in a first piconet of a scatternet to a destination device in a second piconet of the scatternet comprising: receiving the packet at the first device; determining whether the creation of a direct radio communications link between the first device and the destination device is possible; and if it is not possible, forwarding the packet within the scatternet.

### TECHNICAL FIELD

Embodiments of the present invention relate to a method or device for routing a packet in a scatternet, such as a Bluetooth (trademark) scatternet.

### BACKGROUND OF THE INVENTION

Bluetooth (trademark) is a low power radio frequency (LPRF) packet communications technology. Bluetooth enabled devices can create ad-hoc wireless networks (piconets) via short-range radio frequency hopping spread spectrum (FHSS) communication links in the 2.4 GHz frequency spectrum. These links may be of the order of 10 m.

The Bluetooth devices are frequently mobile and the nodes of a piconet may change.

A piconet is controlled by a Master and can contain up to seven Slaves. The piconet has a star-topology with the Master as the central node and the Slaves as dependent nodes. The timing of the piconet is controlled by the Master and the Slaves synchronize their Bluetooth clocks to the Bluetooth clock of the Master.

All communications within the piconet include the Master. A Slave cannot communicate directly with another Slave in the piconet, but instead communicates with the Master which then communicates with the other Slave.

The communications within the piconet are time divided into slots of 625 microsecond duration. Communications from the Master may only commence in even numbered time slots and communications from the Slaves may only commence in odd numbered time slots.

The frequency at which a communication is made is dependent upon the time slot at which it begins. The Master defines a frequency hopping sequence that all the devices in a piconet share. The sequence hops every 625 microseconds in phase with the Master Bluetooth clock.

The Master creates a piconet by paging its slaves one by one. All Bluetooth devices that receive the paging, by page-scan, synchronize their Bluetooth clocks to that of the Master and communicate with the Master using the Master's Bluetooth Device address as the packet Access Code. Any Slave can request to become the Master of a piconet.

Piconets may overlap, so a Slave in one piconet can be a Master or Slave in an adjacent piconet. A collection of interconnected piconets is called a scatternet. The Bluetooth device that is common to two piconets, the interconnecting node, is able to route packets from one piconet to the connected piconet. Thus packets can be routed from a source within a first piconet of a scatternet to a remote destination that is within a second piconet of the scatternet. A routing mechanism is, however, required to route a packet from source to destination.

A low latency routing mechanism may maintain a current routing table at each node of the scatternet. When a node is added to the scatternet or leaves the scatternet then each of the routing tables is updated. The advantage of this mechanism is that routing from source to destination is fast. One disadvantage is that each node must be capable of maintaining a routing table. Another disadvantage is that the maintenance of the routing tables becomes very inefficient if the scatternet changes frequently, as all routing table must also be changed frequently which uses up a large amount of bandwidth.

An ad-hoc mechanism may be used to reduce the overheads for routing, but with a concomitant increase in latency. In an ad-hoc mechanism a route is only determined when a first packet is to be sent to a new destination device. The source initiates a routing request packet identifying a destination node, which is broadcast in the source's piconet. The interconnecting node(s) of that piconet insure that the route request is broadcast in the connected piconets and so on. Thus the route request is broadcast within the scatternet. When a node receives a route request, it includes its Bluetooth address and forwards it. Thus, a received route request contains a history of all nodes that it has passed through. When the destination node eventually receives the route request, it sends it back within a packet to the source node, using the history for routing. The source node takes the history from the packet and uses it to route a message packet to the destination node. This mechanism may suffer from high latency before the first packet to a new destination device can be sent, as a route may need to be determined. Any subsequent packets to the same destination device may use the same route.

The topology of the scatternet once formed remains unchanged except for devices leaving and joining the scatternet. However, the nodes in the scatternet may be mobile and the original scatternet topology may become inefficient for routing packets between certain nodes as the nodes move.

Yong Liu, Kyung J. Lee and Tarek N. Saadawi, “A Bluetooth Scatternet-Route Structure for Multihop Ad Hoc Networks,” IEEE Journal on Selected Areas in Communications, Vol. 21, No. 2, February 2003 suggests on-demand scatternet formation. A scatternet is only formed when a route from a source to a destination is requested. This avoids the problem of a scatternet becoming inefficient as the nodes move because it is only created when it is required. However, as no links exist between devices it may take a long time to establish the scatternet.

It would be desirable to improve the manner in which a packet is routed from a first device of an existing scatternet to a destination device of that scatternet.

### BRIEF SUMMARY OF THE INVENTION

According to one embodiment of the invention there is provided a method of delivering a packet from a first device in a first piconet of a scatternet to a destination device in a second piconet of the scatternet comprising: creating a direct radio communications link between the first device and the destination device; and transmitting the packet via the direct radio communications link.

According to another embodiment of the invention there is provided a method of delivering a packet from a first device in a first star-topology sub-network of a distributed low power radio frequency network to a destination device in a second star-topology sub-network of the distributed network comprising: creating a direct low power radio frequency communications link between the first device and the destination device; and transmitting the packet via the direct low power radio frequency communications link.

According to another embodiment of the invention there is provided a device for participating in a first piconet of a scatternet and for delivering a packet to a destination device in a second piconet of the scatternet comprising: means for creating a new direct radio communications link to the destination device while maintaining an existing direct radio communications link within the first piconet; and a radio transmitter for transmitting the packet via the new direct communications link.

According to another embodiment of the invention there is provided a method of delivering a packet from a first device in a first piconet of a scatternet to a destination device in a second piconet of the scatternet comprising: receiving the packet at the first device; determining whether the creation of a direct radio communications link between the first device and the destination device is possible; and if it is not possible, forwarding the packet within the scatternet. The packet may be a route request packet (RREQ), in which case the method searches a route from a first device in a first piconet of a scatternet to a destination device in a second piconet of the scatternet.

According to another embodiment of the invention there is provided a method of determining a route from a source device in a first piconet of a scatternet to a destination device in a second piconet of that scatternet via an intermediate device comprising, before generating a routing request, determining at the source device whether the creation of a direct radio communications link between the source device and the destination device is possible; and if it is not possible, generating at the source device a routing request for forwarding within the scatternet.

According to another embodiment of the invention there is provided a method of delivering a packet from a first device in a first piconet of a scatternet to a destination device in a second piconet of that scatternet comprising: creating a third piconet between the first piconet and the second piconet; and transmitting the packet via the third piconet.

Embodiments of the invention enable a shorter transmission route to be found between two nodes of a scatternet. This saves bandwidth within the piconet, reduces interference and power consumption within the scatternet.

### BRIEF DESCRIPTION OF DRAWINGS

For a better understanding of the present invention reference will now be made by way of example only to the accompanying drawings in which:

FIG. 1 illustrates an example of a Bluetooth (trademark) scatternet;

FIG. 2 illustrates a Bluetooth (trademark) scatternet that has been adapted to route a packet;

FIGS. 3A, 3B and 4A, 4B illustrate alternative processing of a receive routing request; and

FIG. 5 schematically illustrates a Bluetooth enable device.

### DETAILED DESCRIPTION OF EMBODIMENT(S) OF THE INVENTION

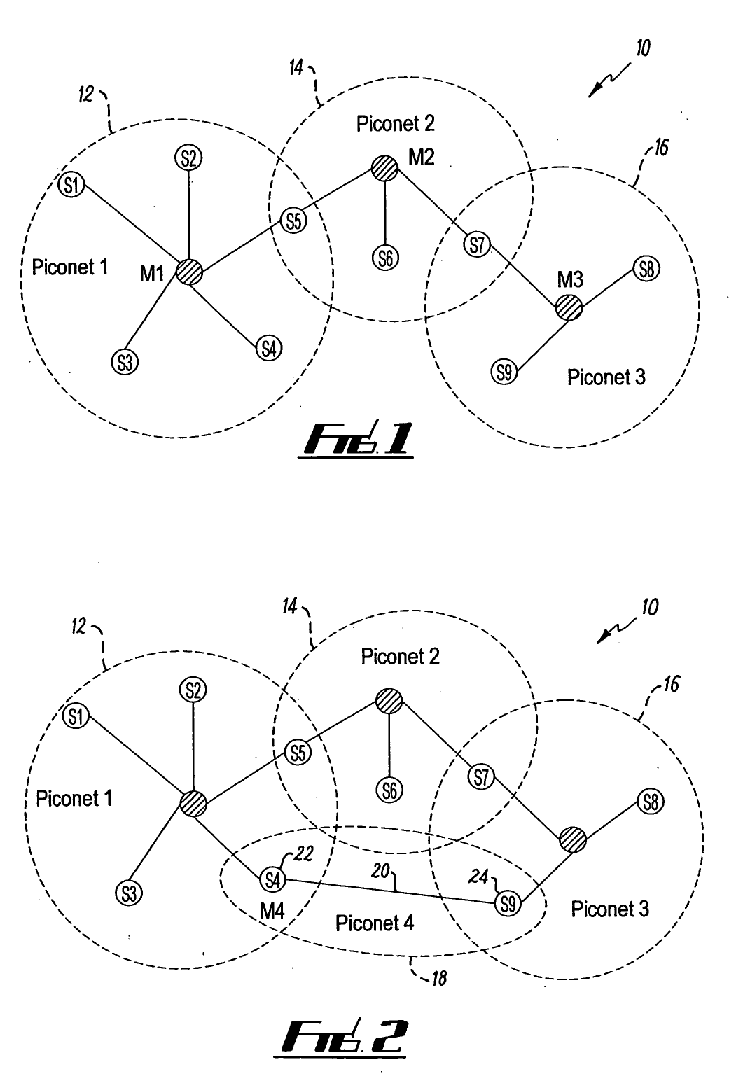

FIG. 1 illustrates an example of a Bluetooth (trademark) scatternet 10. The scatternet is a distributed LPRF network that comprises three separate piconets that are interconnected by common nodes. Each piconet has a star-topology comprising a central Master node and a plurality of dependent Slave nodes. Each piconet forms a sub-network of the scatternet 10.

A first piconet 12 is controlled by the Master M1 and includes five Slaves S1, S2, S3, S4 and S5. A second piconet 14 is controlled by the Master M2 and includes three Slaves S5, S6, S7. A third piconet 16 is controlled by the Master M3 and includes three Slaves S7, S8 and S9. The Slave S5 is a common node interconnecting the first piconet 12 with the second piconet 14. The Slave S7 is a common node interconnecting the second piconet 14 with the third piconet 16.

Each of the Masters and Slaves is a Bluetooth-enabled device. Such a device may operate as a Master or a Slave depending upon circumstances. The Bluetooth devices may be mobile.

Embodiments of the invention allow the topology of the scatternet to be changed to improve the routing of a packet between a first Bluetooth device and a destination Bluetooth device.

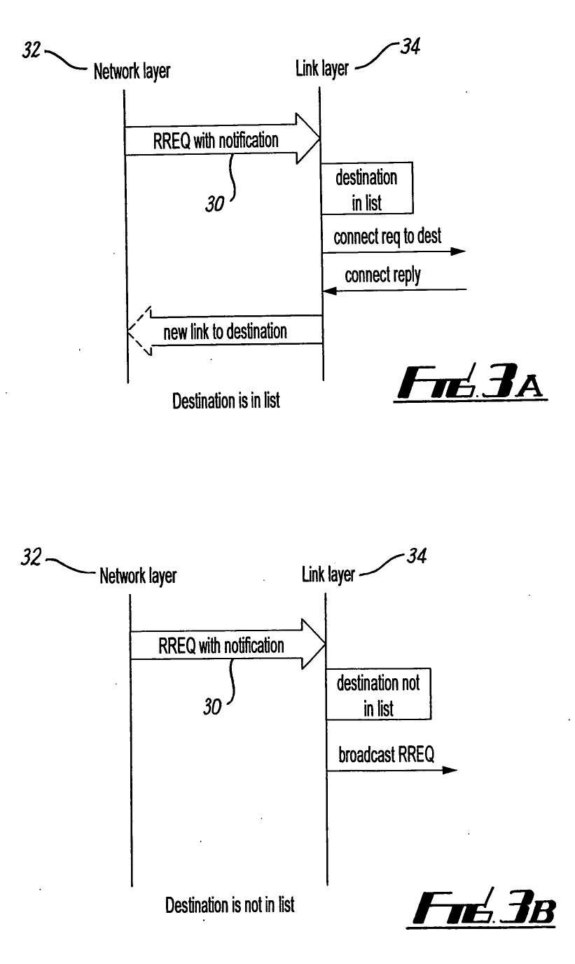

FIG. 2 illustrates a new topology for the scatternet 10 that is created to improve the routing of a packet between a first Bluetooth device 22 and a destination Bluetooth device 24. The adapted scatternet 10 comprises an additional direct LPRF radio communications link 20 between the first Bluetooth device 22, which operates as the Slave S4 in the first piconet 12, and the destination Bluetooth enabled device 24, which operates as the Slave S9 in the third piconet 16. This new direct radio communications link 20 forms a new fourth piconet 18 that includes the first device 22 as its Master M4 and the destination device 24 as its Slave S9.

The topology of the scatternet 10 changes as a result of routing a radio packet. In order to route a packet from a first device 22 in one piconet 12 to a destination device 24 in a different piconet 16, a direct LPRF radio communications link 20 is created between the first device 22 and the destination device 24. The direct radio communications link creates a short-circuit in the network topology. The radio packet can then be sent via this short-cut.

The direct radio communications link 20 may be temporary. For example, it may be released after a predetermined period of inactivity of the link.

The first device 22 may need to find an optimal route to the destination device because it needs to transmit data originating at the first device to the destination terminal 24, or because it needs to forward a received routing request towards the destination terminal.

If the first device 22 needs to transmit data originating at the first device to the destination terminal 24, then in this case the packet to be routed is a data packet that originates at the first device i.e. the first device is the source of the packet. Before generating a routing request packet, the first device 22 determines whether the creation of a direct radio communications link between the source device 22 and the destination device is possible 24. If it is possible, the first device creates a direct LPRF radio communications link 20 between the first device 22 and the destination device 24 and transmits the data packet via the direct radio communications link 20. If it is not possible, a routing request packet is forwarded within the original scatternet 10. The first device 22 adds its Bluetooth address to the history contained in the routing request packet before it is forwarded.

If the first device 22 needs to forward a received routing request towards the destination terminal, the first device determines whether the creation of a direct radio communications link 20 between the first device 22 and the destination device 24 is possible. If it is possible, the first device 22 creates a direct LPRF radio communications link 20 between the first device 22 and the destination device 24 and transmits the routing request packet via the direct radio communications link 20. The first device adds its Bluetooth address to the history contained in the routing request before it is forwarded. If it is not possible, the received routing request packet is forwarded within the original scatternet 10. The first device 22 adds its Bluetooth address to the history contained in the routing request before it is forwarded.

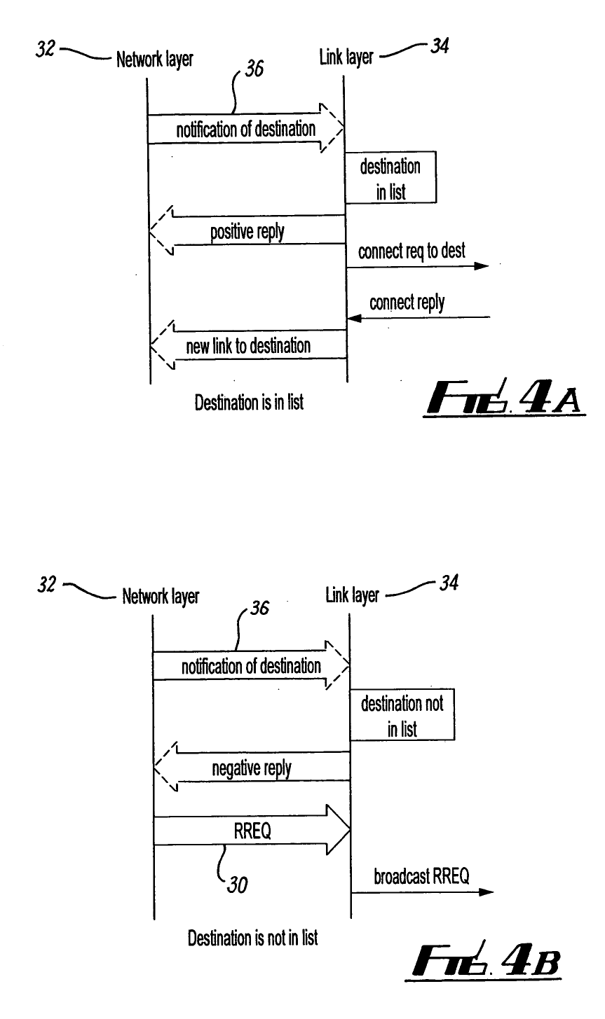

In FIGS. 3A and 3B, the received routing request packet is transferred from a network layer 32 to a link layer 34. The routing request packet 30 includes the address of the destination device. The link layer determines whether it is possible to create a direct radio communications link 20 from the first device 22 to the destination device 24. If it is possible, the link layer 34 creates a direct radio communications link 20 with the destination device 24 as illustrated in FIG. 3A. However, if it is not possible the Link layer forwards the received routing request packet within the scatternet 10 as illustrated in FIG. 3B.

In FIGS. 4A and 4B, the received routing request packet is buffered in a network layer 32 and a notification 36 comprising the address of the destination device is transferred to a Link layer 34. The link layer 34 determines whether it is possible to create a direct radio communications link 20 from the first device 22 to the destination device 24. If it is possible, the Link layer creates a direct radio communications link 20 with the destination device 24 as illustrated in FIG. 4A. However, if it is not possible, the link layer replies 38 to the network layer 32 which transfers the received routing request packet 30 to the link layer 34 for forwarding within the scatternet 10.

The step of determining whether the creation of a direct radio communications link 20 between the source device 22 and the destination device 24 is possible may be achieved by maintaining at the first device 22 a list of devices that are within radio communication range of the first device 22 and determining whether the address of the destination device 24 appears within that list. If a match is found, the Link layer in the first device 22 creates a new radio communication link 20 to the destination device 24.

The list comprises, for each device within communication range, an entry comprising an address, a clock offset and the time at which the entry was last updated. The list is maintained using the Bluetooth Inquiry procedure, which provides in reply a Bluetooth address and a local Bluetooth clock value for each active device within radio communication range. The local Bluetooth clock value can be converted to an offset value at the first device 22 by immediate comparison with the Bluetooth clock value of the first device 22.

It should be appreciated that each node in the network will maintain a list of devices that are within radio communications range and is operable to create a new direct radio communication link as described in relation to the first device 22.

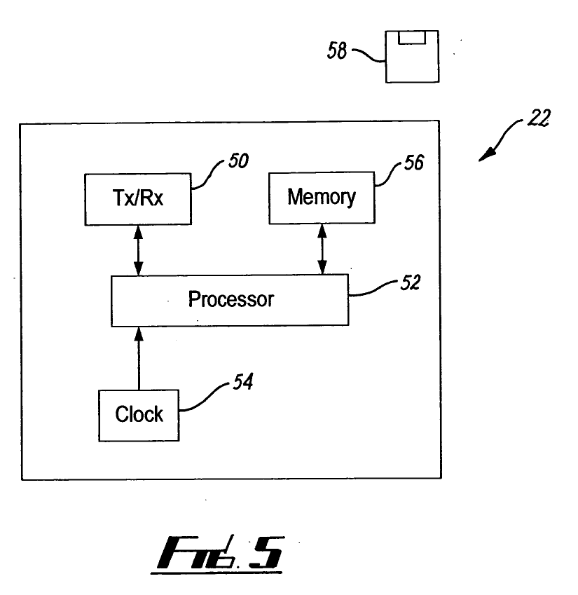

FIG. 5, schematically illustrates a Bluetooth device that is suitable for use as the first device 22. The device 22 comprises a LPRF transceiver 50, a processor 52, a Bluetooth clock 54 and a memory 56. The processor 52 is connected to the LPRF transceiver 50, which is used to create a physical radio communications channel to another device. The processor 52 is additionally connected to the Bluetooth clock 54 and connected to read from and write to the memory 56.

The processor 52 controls the operation of the first device 22 in accordance with computer program instructions stored in the memory 56. These program instructions may be stored in the memory from a carrier 58, which embodies the computer program instructions.

The processor 52, for example, enables participation of the first device 22, as a Slave, in the first piconet 12. the processor 52 uses the Bluetooth address of the Master M1 and a clock offset for the Master M1. The processor 52 uses the clock offset to synchronise the Bluetooth clock 54 to the Bluetooth clock of the Master M1. The processor 52 uses the Bluetooth address of the Master M1 as an Access Code. This code is used to receive packets from the first piconet 12 and to address packets within the first piconet 12. The processor 52 also uses the Bluetooth address of the Master M1 to recreate a frequency hopping sequence for the first piconet 12. The phase within this sequence is determined by the Bluetooth clock of the Master M1 emulated at the processor 52.

The processor 52, additionally enables the creation of a new direct radio communications link 20 to the destination device 24, instead of sending a packet via the scatternet 10.

The processor 52 is arranged to periodically control the LPRF transceiver 50 to initiate an Inquiry. The results of the Inquiry are received by the LPRF transceiver 50 and relayed to the processor 52. The processor 52 uses these results to maintain in the memory 56 a list of the devices with which the first device 22 is able to create a new direct radio communications link 20.

The processor 52 is additionally arranged to compare an address of the destination device with the addresses of the list, and if a positive comparison is made initiate the creation of a new direct radio communications link 20.

The new direct radio communications link 20 is created by the processor operating as a Master. It pages the destination device 24 and joins it to a newly created piconet 18. This creates a direct radio communications link 20 as a logical link. This logical link can be utilized to form a physical channel using the LPRF transceiver 50. The physical channel transports the packet to the destination device.

The processor 52 enables the first device 22 to participate as Master M4 in the fourth piconet 18 while it participates as a Slave S4 in the first piconet 12.

The processor 52 uses the Bluetooth address of the first device 22 and the Bluetooth clock 54 to operate as Master M4 in the fourth piconet 18. The processor 52 uses the Bluetooth address of the first device 22 as an Access Code. This code is used to receive packets from the fourth piconet 18 and to address packets within the fourth piconet 18. The processor 52 also uses the Bluetooth address of the first device 22 to recreate a frequency hopping sequence for the fourth piconet 18. The phase within this sequence is determined by the Bluetooth clock 54 of the first device 22.

In the above-described example, the new radio communications link 20 is made between two devices that operate as Slaves in different piconets. The new radio communications link forms a new piconet 18. One of the devices 22 additionally operates as a Master M4 in the new piconet 18 as well as a Slave S4 in the existing first piconet 12. The other of the devices 24 additionally operates as a Slave in the new piconet 18 as well as a Slave in the existing third piconet 16. Consequently, communications via the new radio communications link 20 comprise packets that include in their header the Bluetooth device address of the first device 22. These packets are communicated with a frequency dependent upon a phase, dependent upon a Bluetooth clock of the first device 22, within a frequency hopping sequence determined by the Bluetooth device address of the first device 22.

In another example, the new radio communications link may be made between two devices one of which operates as a Slave and the other of which operates as a Master in different piconets.

If the first device is the Slave in a first piconet and the destination device is the Master in a second piconet, the new radio communications link forms a new third piconet. The first device additionally operates as a Master in the new third piconet as well as a Slave in the existing first piconet. The destination device additionally operates as a Slave in the new third piconet as well as a Master in the existing second piconet. Consequently, communications via the new radio communications link comprise packets that include in their header the Bluetooth device address of the first device that are communicated with a frequency dependent upon a frequency hopping sequence determined by Bluetooth device address of the first device and a phase determined by the Bluetooth clock of the first device.

If the first device is the Master of a first piconet and the destination device is a Slave of a second piconet, the new radio communications link joins the destination device as a Slave to the first piconet. It may be necessary for the first device to park one of the Slaves already joined to the first piconet to enable this. The first device operates as a Master in the existing first piconet. The destination device operates as a Slave in the existing first piconet as well as a Slave in the existing second piconet. Consequently, communications via the new radio communications link comprise packets that include in their header the Bluetooth device address of the first device that are communicated with a frequency dependent upon a frequency hopping sequence determined by the Bluetooth device address of the first device and a phase determined by the Bluetooth clock of the first device.

In another example, the new radio communications link may be made between two devices that operate as Masters in different piconets. If the first device is the Master of a first piconet and the destination device is the Master of a second piconet, the new radio communications link joins the destination device as a Slave to the first piconet. It may be necessary for the first device to park one of the Slaves already joined to the first piconet to enable this. The first device operates as a Master in the existing first piconet. The destination device operates as a Slave in the existing first piconet as well as a Master in the existing second piconet. Consequently, communications via the new radio communications link comprise packets that include in their header the Bluetooth device address of the first device that are communicated with a frequency dependent upon a frequency hopping sequence determined by Bluetooth device address of the first device and a phase determined by the Bluetooth clock of the first device.

It should be appreciated that creating a direct radio communications link between the first device and the destination device involves creating a logical communications channel. It does not imply the existence of a permanent physical communications channel.

Although embodiments of the present invention have been described in the preceding paragraphs with reference to various examples, it should be appreciated that modifications to the examples given can be made without departing from the spirit and scope of the invention.

1. A method of delivering a packet from a first device in a first piconet of a scatternet to a destination device in a second piconet of the scatternet comprising:
creating a direct radio communications link between the first device and the destination device; and
transmitting the packet via the direct radio communications link.

2. A method as claimed in claim 1, wherein the destination device is joined to the first piconet.

3. A method as claimed in claim 1, wherein the step of creating a direct radio communications link creates a third piconet between the first piconet and the second piconet.

4. A method as claimed in claim 3, wherein the first device operates as Master of the third piconet.

5. A method as claimed in claim 1, wherein the scatternet has a topology defined at initiation of the scatternet and creating the direct radio communications link adjusts the topology of the scatternet.

6. A method as claimed in claim 4, wherein the direct radio communications link creates a short-circuit in the network topology.

7. A method as claimed in claim 1, wherein a piconet is a star-topology low power radio frequency network comprising a Master as a central node and one or more Slaves as dependent nodes, each of which has a radio communications link to the Master, and a scatternet is a distributed low power radio frequency network comprising a plurality of piconets that are interconnected by radio communication links.

8. A method as claimed in claim 1, wherein the first device and/or the destination device are mobile.

9. A method as claimed in claim 1, further comprising:
determining whether the creation of a direct radio communications link between the first device and the destination device is possible.

10. A method as claimed in claim 9, wherein the packet comprises an address of the destination device and the step of determining uses the identity of the destination device.

11. A method as claimed in claim 10, wherein the step of determining comprises determining if the destination device is within radio communication range of the first device.

12. A method as claimed in claim 9, wherein the first device maintains a list of devices within radio communication range.

13. A method as claimed in claim 12, wherein the list comprises, for each device within communication range, an address and a clock offset.

14. A method as claimed in claim 12, wherein the list is maintained using the Bluetooth Inquiry procedure.

15. A method as claimed in claim 12, wherein the step of determining comprises the first device determining whether the destination device is included in the list.

16. A method as claimed in claim 15, wherein the comparison occurs within the Bluetooth Link layer.

17. A method as claimed in claim 1, wherein the direct radio communications link is temporary.

18. A method as claimed in claim 17, wherein the direct radio communications link is released after a predetermined period of inactivity.

19. A method as claimed in claim 1, wherein the packet is a routing request.

20. A method of delivering a packet from a first device in a first star-topology sub-network of a distributed low power radio frequency network to a destination device in a second star-topology sub-network of the distributed network comprising:
creating a direct low power radio frequency communications link between the first device and the destination device; and
transmitting the packet via the direct low power radio frequency communications link.

21. A carrier embodying a computer program which when loaded into a processor enables a method as claimed in claim 1.

22. A device for participating in a first piconet of a scatternet and for delivering a packet to a destination device in a second piconet of the scatternet comprising:
means for creating a new direct radio communications link to the destination device while maintaining an existing direct radio communications link within the first piconet; and
a radio transmitter for transmitting the packet via the new direct communications link.

23. A method of delivering a packet from a first device in a first piconet of a scatternet to a destination device in a second piconet of the scatternet comprising:
receiving the packet at the first device;
determining whether the creation of a direct radio communications link between the first device and the destination device is possible; and
if it is not possible, forwarding the packet within the scatternet.

24. A method as claimed in claim 23, further comprising adding an address of the first device to the packet before forwarding it.

25. A method as claimed in claim 23, wherein the received packet is transferred from a network layer to a link layer and, if possible, the link layer creates a direct radio communications link with the destination device and, if not possible, the link layer forwards the received packet.

26. A method as claimed in claim 23, wherein the received packet is buffered in a network layer and a notification comprising the address of the destination device is transferred to a link layer and, if possible, the link layer creates a direct radio communications link with the destination device and, if not possible, replies to the network layer which transfers the received packet to the link layer for forwarding.

27. A method as claimed in claim 23, wherein the method further comprises, if the creation of a direct radio communications link between the first device and the destination device is possible, creating a direct radio communications link between the first device and the destination device.

28. A method as claimed in claim 23, wherein the received packet is a route request packet and the method further comprises, if the creation of a direct radio communications link between the first device and the destination device is possible, transmitting a reply packet to a source of the received route request packet.

29. A method of determining a route from a source device in a first piconet of a scatternet to a destination device in a second piconet of that scatternet comprising, before generating a routing request, determining, at the source device, whether the creation of a direct radio communications link between the source device and the destination device is possible; and if it is not possible, generating, at the source device, a routing request for forwarding within the scatternet.

30. A method as claimed in claim 29, wherein the method further comprises, if the creation of a direct radio communications link between the first device and the destination device is possible, creating a direct radio communications link between the first device and the destination device.

31. A method of delivering a packet from a first device in a first piconet of a scatternet to a destination device in a second piconet of that scatternet comprising:
creating a third piconet between the first piconet and the second piconet; and
transmitting the packet via the third piconet.

32. A method as claimed in claim 31, wherein the first device operates as Master of the third piconet.

33. A method as claimed in claim 31, wherein the step of creating a third piconet comprises creating a direct radio communications link between the first device and the destination device.

34. A method as claimed in claim 31, wherein the scatternet has a topology defined at initiation of the scatternet and creating a third piconet aadjusts the topology of the scatternet.

35. A method as claimed in claim 31, wherein the third piconet creates a short-circuit in the network topology.

36. A method as claimed in claim 31, wherein a piconet is a star-topology low power radio frequency network comprising a Master as a central node and one or more Slaves as dependent nodes, each of which has a radio communications link to the Master, and a scatternet is a distributed low power radio frequency network comprising a plurality of piconets that are interconnected by radio communication links.
